(19) United States
(12) Patent Application Publication
(10) Pub. No.: US 2026/0309986 A1
(43) Pub. Date: Oct. 8, 2026

(54) LENS CONTROL DEVICE USING ARTIFICIAL INTELLIGENCE AND SMART VARIABLE-FOCUS LENS AND LENS CONTROL METHOD USING THE SAME

(71) Applicant: Electronics and Telecommunications Research Institute, Daejeon (KR)

(72) Inventors: Sungjun WANG, Daejeon (KR); Moo Seop Kim, Daejeon (KR); Young Mi Song, Daejeon (KR); Chi Yoon Jeong, Daejeon (KR); SuGil Choi, Daejeon (KR)

(73) Assignee: Electronics and Telecommunications Research Institute, Daejeon (KR)

(21) Appl. No.: 19/364,560

(22) Filed: Oct. 21, 2025

(30) Foreign Application Priority Data
Apr. 1, 2025 (KR) 10-2025-0042162

(51) Int. Cl. G02B 27/01; G02C 7/08; G06F 3/01

(52) U.S. Cl. CPC G02B 27/0172; G02C 7/08; G06F 3/013; G02B 2027/0178

(57) ABSTRACT

Disclosed are a lens control device using AI and a smart variable-focus lens and a lens control method using the same. The lens control device using AI includes a gaze determination unit configured to train an artificial intelligence (AI) model by receiving data and a controller configured to control a focus of a lens based on a result value derived by the AI model. The smart variable-focus lens includes a data collection unit configured to collect data for the training of the common sense model, an additional data collection unit configured to collect small-scale data based on a feedback signal, a lens control device using AI, and a variable-focus lens having a changeable focus.

### CROSS-REFERENCE TO RELATED APPLICATION

The present application claims priority to and the benefit of Korean Patent Application No. 10-2025-0042162, filed on Apr. 1, 2025, in the Korean Intellectual Property Office, the entire disclosure of which is incorporated herein by reference.

### BACKGROUND

### 1. Technical Field

The present disclosure relates to a lens control device using artificial intelligence, which can provide a focus suitable for a focus-variable lens user, and a smart variable-focus lens and a lens control method using the same.

### 2. Related Art

Smart glasses according to a conventional technology have problems in that a distance measurement error occurs depending on a reflection degree of a material because a focus is adjusted by a distance sensor mounted on the smart glasses, a user's intent is not incorporated, and a measurement error occurs when the face direction and gaze direction of a user are not matched.

Furthermore, the smart glasses according to a conventional technology have problems in that it is difficult to check an object to become a reference point consistently and accurately in a situation in which several objects are present at the center of a gaze and are rapidly moving and a change in user preference and the gaze pattern of a user is not considered.

A conventional technology has limitations in that convenience is low in battery efficiency or usability aspect because a gaze tracking camera needs to be consistently used in order to take the focus.

### SUMMARY

Various embodiments are directed to providing a control device that can implement an artificial intelligence (AI) learning model and enables a model capable of incorporating user interest to capture major objects in real time based on user preference and to automatically adjust the focus of a lens by calculating a distance value for a corresponding object. Furthermore, various embodiments are directed to providing a control method of updating an AI model through a re-training process based on a user's feedback.

A lens control device using AI according to an embodiment of the present disclosure may include a gaze determination unit configured to train an artificial intelligence (AI) model by receiving data and a controller configured to control a focus of a lens based on a result value derived by the AI model.

In an embodiment, the gaze determination unit may include a common sense model training unit configured to train a common sense model that determines priority of a gaze on the basis of common sense and a preference model training unit configured to train a preference model that aligns results determined by the common sense model by incorporating user preference.

In an embodiment, the controller may include a gaze tracking unit configured to track a gaze fixing point of a user, a determination synchronization unit configured to identify and synchronize whether the gaze fixing point of the user and a gaze determined by the AI model are identical with each other, a focus matching determination unit configured to determine an object by using an algorithm, and a feedback collection unit configured to collect feedback of a user with respect to whether focuses determined by the algorithm are identical with each other.

In an embodiment, the common sense model training unit may include an image encoder configured to encode an image and a text encoder configured to encode text.

In an embodiment, the controller includes a focus matching determination unit using an algorithm. The algorithm may determine whether a result value, which is determined by using a point at which an eye tracker tracks a gaze as a reference point and setting 50 pixels around the reference point as a threshold, is identical with a gaze tracking result value of the eye tracker.

In an embodiment of the present disclosure, a smart variable-focus lens that aligns a focus in real time may include a data collection unit configured to collect data for the training of the common sense model, an additional data collection unit configured to collect small-scale data based on a feedback signal, a lens control device using AI, and a variable-focus lens having a changeable focus.

In an embodiment, the data collection unit may collect data in various environments, may label importance by using an eye tracking camera, may label a natural language including ranking information and category information, may label saliency ranking, and may auto-label new dataset that is not labeled.

In an embodiment, the data collection unit may collect data in various environments. The data may be collected so that a bias does not occur by making difference one or more of a race, gender, an age, and culture of a test subject.

In an embodiment, the data collection unit may generate a dataset by collecting data. The dataset may include one or more of pieces of information on an image, a natural language tag, a saliency ranking label, and a salient object boundary label.

In an embodiment, the data collection unit may generate a dataset by collecting data. The size of the dataset may be increased by repeating a process of auto-labeling a new dataset that is not labeled, re-training a model a dataset generated through auto-labeling, and auto-labeling new data by using the re-trained model.

In an embodiment, the additional data collection unit may collect lesser datasets when a preference model is trained.

In an embodiment of the present disclosure, a method of controlling a variable-focus lens in real time using an AI model may include a model training step using a gaze matching determination unit and a focus signal generation step using a controller.

In an embodiment, the method of controlling a variable-focus lens in real time may further include a data collection step using a data collection unit prior to the model training step, an additional data collection step of collecting feedback of a user after the focus signal generation step, and a model re-training step of re-training a model based on additional data.

In an embodiment, the method of controlling a variable-focus lens in real time may further include a data collection step. The data collection step may include a data collection step of collecting data in various environments, an importance labeling step of labeling importance by using an eye tracking camera, a natural language labeling step of labeling a natural language including ranking information and category information, a saliency labeling step of labeling saliency ranking, and an auto-labeling step of auto-labeling a new dataset that is not labeled.

In an embodiment, the method of controlling a variable-focus lens in real time may further include a data collection step. In the data collection step, the data may be collected so that a bias does not occur by making different a race, gender, age, and culture of a subject.

In an embodiment, the method of controlling a variable-focus lens in real time may further include a data collection step. In the data collection step, a dataset is generated by collecting data. The dataset may include information on an image, a natural language tag, a saliency ranking label, and a salient object boundary label.

In an embodiment, the method of controlling a variable-focus lens in real time may further include a data collection step of generating a dataset by collecting data. The size of the dataset may be increased by repeating a process of auto-labeling a new dataset that is not labeled, re-training a model a dataset generated through auto-labeling, and auto-labeling new data by using the re-trained model.

In an embodiment, the model training step may include a common sense model training step using a common sense model training unit that trains a common sense model and a preference model training step using a preference model training unit that trains a preference model.

In an embodiment, the focus signal generation step may include a gaze tracking step using a gaze tracking unit, a synchronization step using a determination synchronization unit, a focus matching determination step using a focus matching determination unit, and a feedback collection step using a feedback collection unit that collects feedback with respect to whether focuses determined by the algorithm are identical with each other.

In an embodiment, in the additional data collection step, lesser datasets may be collected when the preference model is trained.

According to an embodiment of the present disclosure, user gaze information is analyzed in real time and integrated with sensor information through the training of a preference-based AI model and the synchronization of the eye tracker and the distance sensor. Furthermore, the focus is adjusted based on the characteristics of each user, and a model is consistently updated. There is the possibility that the gaze of a user can be tracked more accurately and a change can be handled compared to the existing auto-focus adjustment glasses through real-time analysis and the consistent updates of the model.

According to an embodiment of the present disclosure, there is an effect in that a top-priority object can be focused accurately by incorporating a user's preference. Furthermore, a model can be consistently updated, and a change in a user can be handled.

Unlike in the existing technology in which gaze tracking and a fixed model are simply used, in an embodiment of the present disclosure, changing visual needs of a user can be immediately handled by incorporating user preference and consistently updating a model based on feedback.

According to an embodiment of the present disclosure, there is an effect in that safety is assured through an inter-sensor redundancy construction. In view of the characteristics of a sensor, modification needs to be performed according to a measurement situation, or another determination mechanism supports the failure of a sensor when the sensor malfunctions due to a change in several environments. Accordingly, it is possible to propose a method capable of providing a solution even in a problematic situation and to derive a more robust result value rather than processing all of result values based on only one sensor. As a result, it is possible to provide a user with more accurate information, and there is robustness by which the failure of one sensor can be temporarily solved although the sensor malfunctions.

However, effects of the present disclosure which may be obtained in the present disclosure are not limited to the aforementioned effects, and other effects not described above may be evidently understood by those skilled in the art from the following description.

Effects of the present disclosure are not limited to the aforementioned effects, and the other effects not described above may be evidently understood by those skilled in the art from the following description.

### BRIEF DESCRIPTION OF THE DRAWINGS

The following drawings attached to this specification illustrate preferred embodiments of the present disclosure, and help to further understand the technical spirit of the present disclosure along with the aforementioned contents of the disclosure. Accordingly, the present disclosure should not be construed as being limited to only contents described in such drawings.

FIG. 1 is a block diagram of a lens control device according to various embodiments.

FIG. 2 is a diagram for describing a lens control process according to various embodiments.

FIG. 3 is a diagram for describing a smart variable-focus lens according to various embodiments.

FIG. 4 is a control flowchart through the lens control device according to various embodiments.

FIG. 5 is a diagram for describing a data collection step in a data collection unit according to various embodiments.

FIG. 6 is a flowchart for describing a method of controlling a variable-focus lens according to various embodiments.

FIG. 7 is a block diagram illustrating a computer system for implementing a method according to an embodiment of the present disclosure.

### DETAILED DESCRIPTION

The aforementioned object, other objects, advantages, and characteristics of the present disclosure and a method for achieving the objects, advantages, and characteristics will become clear with reference to embodiments to be described in detail along with the accompanying drawings.

However, the present disclosure is not limited to embodiments disclosed hereinafter, but may be implemented in various different forms. The following embodiments are merely provided to easily notify a person having ordinary knowledge in the art to which the present disclosure pertains of the objects, constructions, and effects of the present disclosure. The scope of rights of the present disclosure is defined by the writing of the claims.

Terms used in this specification are used to describe embodiments and are not intended to limit the present disclosure. In this specification, an expression of the singular number includes an expression of the plural number unless clearly defined otherwise in the context. The term “comprises” and/or “comprising” used in this specification does not exclude the presence or addition of one or more other components, steps, operations and/or components in addition to mentioned components, steps, operations and/or components.

Advantages and characteristics of the present disclosure and a method for achieving the advantages and characteristics will become apparent from embodiments described in detail later in conjunction with the accompanying drawings. However, the present disclosure is not limited to the disclosed embodiments, but may be implemented in various different forms. The embodiments are merely provided to complete the present disclosure and to fully notify a person having ordinary knowledge in the art to which the present disclosure pertains to the category of the present disclosure. The present disclosure is merely defined by the category of the claims.

Terms used in this specification are used to describe embodiments and are not intended to limit the present disclosure. In this specification, an expression of the singular number includes an expression of the plural number unless clearly defined otherwise in the context. The term “comprises” and/or “comprising” used in this specification does not exclude the presence or addition of one or more other components, steps, operations and/or components in addition to mentioned components, steps, operations and/or components. Throughout the specification, the same reference numerals denote the same components. “And/or” includes each of mentioned components and all combinations of one or more of mentioned components. Although the terms “first”, “second”, etc. are used to describe various components, these components are not limited by these terms. These terms are merely used to distinguish between one component and another component. Accordingly, a first component mentioned hereinafter may be a second component within the technical spirit of the present disclosure.

All terms (including technical and scientific terms) used in this specification, unless defined otherwise, will be used as meanings which may be understood in common by a person having ordinary knowledge in the art to which the present disclosure pertains. Furthermore, terms defined in commonly used dictionaries are not construed as falling outside dictionary meanings unless specially defined otherwise. In the description, the same reference numeral denotes substantially the same component. Under such a rule, descriptions may be given by citing contents illustrated in several drawings, and contents that are determined to be evident to those skilled in the art or that are repeated may be omitted.

Hereinafter, a proposed background of the present disclosure is described and embodiments of the present disclosure are then described.

A visual aid is a device having various focus distances in order to align the eyesight of a user. Glasses and a contact lens are representative devices of the visual aid. According to the development of the technology, a visual aid that aligns the eyesight without a lens using a variable-focus lens was developed.

In the existing visual aids, it is difficult for a user to adjust the focus whenever the user views various distances because the existing visual aids provide only a fixed focal distance or depend on a method of manually adjusting the focus. Accordingly, smart glasses that automatically adjust the focus of an object by calculating a distance value between specific objects is being developed, but has limitations in that the smart glasses has a narrow viewing angle and does not handle a focus that is changed with advancing years and different user features.

Specifically, a fixed focus providing device and a device using a focus adjustment method has the following limitations. Glasses that provide a fixed focus does not provide a correct focus when the gaze of a user is changed. The device using the focus adjustment method, such as a multi-focus lens, has a difficult manipulation because a delicate manipulation is required and has limitations in that the distortion of a field of view may occur.

Smart glasses according to a conventional technology has problems in that a distance measurement error may occur depending on a material that is well reflected because the focus is adjusted by a distance sensor mounted on the smart glasses, user intent is not incorporated, and a measurement error occurs when the face direction and gaze direction of a user are not matched.

Furthermore, in the case of the smart glasses according to a conventional technology, it is difficult to check an object to become a reference point consistently and accurately in a situation in which several objects are present at the center of a gaze and are rapidly moving and a change in user preference and the gaze pattern of a user are not considered.

A conventional technology has limitations in that convenience is low in battery efficiency or usability aspect because a gaze tracking camera needs to be consistently used in order to take the focus.

The present disclosure has been proposed to solve the aforementioned problems, and provides a lens control device which controls a lens in real time by using a method of training an artificial intelligence (AI) model, which can incorporate common sense and personal preference and handles a change through consistent model updates.

In an embodiment, the lens control device can provide a user with optimal view information by analyzing information on the gaze of a user through AI in real time, checking an object to be observed and the location of the object, and changing and adjusting a focus based on a distance from the object. Furthermore, the lens control device controls a variable focus lens by consistently updating a model through new data in accordance with a change of user preference or a change of aging or eyesight.

FIG. 1 is a block diagram of a lens control device according to various embodiments.

Referring to FIG. 1, a lens control device 100 according to an embodiment includes a gaze determination unit 120 and a controller 140. Specifically, the gaze determination unit 120 includes a preference model training unit 121 and a common sense model training unit 122. The controller 140 includes a gaze tracking unit 141, a determination synchronization unit 142, a focus matching determination unit 143, and a feedback collection unit 144.

The common sense model training unit 122 may include a model that constructs saliency ranking. Specifically, the common sense model training unit 122 may include a model that outputs an output value (e.g., segment logit) as an output, like a salient object detection model that contains the order of importance in an environment including five or more multiple objects when receiving information on a surrounding environment in the form of a live view through a camera.

Hereinafter, a detailed method of generating a common sense model is described. In order to generate a model close to a model for a human's common sense, data and a model need to have multi-modality. The common sense model needs to be a model capable of inferring a relation between data. Common performance needs to be produced from several situations through a rich dataset into which preference of various labelers has been incorporated without a bias. Data that are received by the common sense model also includes a natural language tag label having ranking information and category information, in addition to an image, a salient label, and a ranking label. Accordingly, the common sense model may be trained by inputting both a natural language and image information thereto. To this end, the encoder of the common sense model may include an image encoder and a text encoder, and receives each image and natural language tag as an input. The latent of the encoder, which is compressed by the text encoder, is input to a transition encoder for a combination with image latent. The output of the transition encoder and the latent of the image encoder are combined through a cross-attention process, and a model decoder outputs a final salient object logit, thereby training the common sense model. As in a data proliferation process to be described hereafter, the improvement training of the model may also be performed along with the proliferation of data, including a method of training the model through the existing dataset and performing auto-labeling again as an improved model after the auto-labeling is performed. Accordingly, the model can be trained while watching a rich dataset. Detailed training of the model is described below. A model close to a model for common sense may be generated by training the model through a detection label necessary for the detection of a salient object and also training the model through a natural language label including ranking information and category information like a category label. The model through such training can provide a primary criterion in lens control. The model may be trained by using all of collected data.

The preference model training unit 121 is a model training unit that provides a guideline to an object that needs to be focused by incorporating user preference as top priority above common sense.

Hereinafter, a detailed method of generating a preference model is described. In order to generate the preference model, it is necessary to 1) incorporate environment information suitable for a user and 2) reset a weight based on personal preference. The user may first collect data suitable for a user environment, may collect 50 to 100 copies of data in an environment (e.g., a company, a home, or an environment for a way to and from work) in which the user stays mainly through glasses, may determine object priority for each photo in several tens of captured photos, and may perform labeling. In the case of a large-scale common sense model, it is assumed that a mask derivation and object detection ability is excellent in various situations because the large-scale common sense model has been trained based on data and transformer-based multi-modal data. In a process of re-training the preference model, output information of the common sense model may be used without performing a boundary and detection label modification task that requires a significant time. However, the user may perform a modification task that assigns priority again because priority different from common sense may be assigned to each person in a portion in which saliency ranking is determined. A photo to which several tens of annotations have been applied is input to knowledge distilled from the common sense model again. The preference model is re-trained by a new weight in a consistent training manner. Accordingly, the weight may be modified again by a model that is suitable for a personal environment and personal preference of the user. In this case, a finally trained model has the stability of a base model, and also has generality in which an inter-plasticity balance that occurs because preference is incorporated can be well adjusted. Accordingly, the finally trained model has the ability to determine a top-priority target object the focus of which is controlled rapidly and accurately. A final output signal (i.e., including priority object detection information and ranking information) derived by the gaze determination unit 120 is transmitted to the controller 140 that performs sensor-AI synchronization. After the data collection and the training of the common sense model and the preference model is performed, the preference model is capable of real-time recognition processing. The processing of the results of the gaze determination unit is performed through the preference model. Hereinafter, effects of the lens control device by the gaze determination unit are described.

When a person recognizes an environment by checking user preference, an AI model that determines an object that is most attractively viewed and takes the focus on the object may be implemented. Specifically, two reference points may be used. The first reference point is a common sense reference point. The common sense reference point may be designed by determining the place to which the gazes of most people are directed as priority when the gaze of a person is directed toward a surrounding environment. The first reference point may apply an individual variation in designing the AI model, and thus becomes a primary filter with respect to noise and an outlier which may suddenly occur. For the role of the primary filter, it is necessary to design a model that extracts importance in various environments by uniformly collecting test subjects so that a bias does not occur in gender, nationality, race, and an age and performing gaze fixation tracking. Accordingly, there is an effect in that recognition stability can be reinforced in various environments because the base model supplements a situation in which a wrong weight is learnt and thus gaze information bounces occurs although the situation occurs.

If a base AI model having common sense is the first reference point that assigns the stability of selection, the second reference point is for priority object re-alignment that is suitable for individual preference and interest. When two to three candidates which may be determined to be major objects are present, the most important object is selected based on user preference from a group of the major objects along with an eye tracker. In order to select the major objects, a reference point is reset based on the user preference in various environments through the re-training of the base model, and the focus is automatically adjusted based on the reference point. Accordingly, it is possible to minimize visual fatigue and improve inconvenience of manual focus adjustment by automatically re-adjusting the focus in various situations.

In other words, the gaze determination unit 120 includes the AI model. The AI model included in the gaze determination unit 120 learns common sense for the primary filtering of a determination from unbiased data and finds an object to be detected as top priority by incorporating user preference based on the common sensing. The AI model synchronizes result values determined by a common sense unit and a preference unit when a surrounding environment is input, and determines a top-priority object that is considered to be most suitable based on the result values as the first priority to be focused. Corresponding information is transmitted to the controller 140 to be synchronized with a depth sensor and the eye tracker.

The controller 140 matches the eye tracker and the distance sensor with a top-priority object derived from the AI model. Furthermore, the controller receives a signal that detects a customized top-priority interest object through the AI model. Thereafter, the controller 140 transmits a control signal to a focus-variable lens through the gaze tracking unit 141, the determination synchronization unit 142, the focus matching determination unit 143, and the feedback collection unit 144.

The gaze tracking unit 141 is based on gaze information received from the eye tracker. Before an interest object is detected by the AI model, the eye tracker of variable focus glasses plays a role of tracking the gaze fixing point of a user, consistently monitoring the accuracy of an object detection algorithm, supplementing a determination of the AI model, and generating a feedback signal for additional training. Accordingly, there is an effect in that a user can consistently make an accurate focus change.

The determination synchronization unit 142 identifies whether a top-priority object detected by the AI model and a top-priority object of a gaze detected by the eye tracker are identical with each other, and synchronizes the top-priority objects. To this end, the determination synchronization unit 142 sets a region of interest (ROI) around gaze fixing points (pixels) that are tracked by the eye tracker as an area (in an embodiment, 50 pixels) of surrounding specific pixels, which has a circle form.

The focus matching determination unit 143 determines an object by using an algorithm which may be constructed based on pseudo code illustrated in a FIG. 1. Hereinafter, the contents of the pseudo code are described in detail.

### [FIG. 1]

Algorithm 1 Pseudo-code

```
while true do
  flag1 = 0
  flag2 = 0
  threshold = 50px
  if AI judgment falls within eye-tracker ROI then
    if yes then
      Find the most significant object based on AI judgment
      Align eye-tracker fixation point with AI judgment
      Calculate the midpoint of the corresponding object
      Calculate distance after matching ToF sensor
    else if no then
      if exceeds threshold then
        flag1 += 1
        if flag1 >10 then
          Print “Re-training needed”
          break
        continue
      flag2 += 1
      Find the most significant object based on AI judgment
      Align fixation point with the closest major object
      Calculate midpoint of corresponding object
      Calculate distance after matching ToF sensor
      if flag2 >30 then
        Print “Re-training due to change”
```

The focus matching determination unit 143 determines how much the tracking data of the eye tracker and an AI determination value are matched by comparing the tracking data and the AI determination value. Specifically, the focus matching determination unit 143 determines how much an AI determination value is identical with the gaze tracking result value of the eye tracker by using a point at which the eye tracker currently tracks the gaze of a user as a reference point and placing a preset specific region (e.g., 50 pixels) around the reference point as a threshold reference value. When the AI determination value is included in the result value ROI of the eye tracker as a result of the determination of the focus matching determination unit 143, the focus matching determination unit 143 finds the most important object as the AI determination value and aligns an eye tracker fixation point and the AI determination value. Thereafter, the focus matching determination unit 143 may calculate the middle point of the most important object and calculate a distance value by placing a TOF sensor at the middle point. In contrast, when the result value ROI of the eye tracker and the AI determination value are not identical with each other, the focus matching determination unit 143 checks a case in which the result value ROI and the AI determination value are not identical with each other based on a flag variable, derives a top-priority object by using the AI determination value as top priority, and aligns the depth sensor with the AI determination value. When the flag variable falls outside a specific value, the focus matching determination unit 143 determines a change of user preference or determines whether to re-train a determination model by determining that the determination model is not correct. The focus matching determination unit 143 may determine both sensor alignment and the re-training through such a process.

The determination synchronization unit 142 synchronizes the gaze point of the eye tracker and the AI determination object. Furthermore, the determination synchronization unit generates a final control signal for the lens by measuring a distance up to a final middle point of the top-priority object.

As a result, the lens control device transmits a control signal generated by the controller 140 to the focus-variable lens. The focus-variable lens is automatically adjusted by the control signal. Accordingly, an object that is gazed by a user can be accurately identified based on user interest, and the focus of the user can be automatically changed by measuring a distance up to the object in real time. Accordingly, there is an effect in that a constant view can be provided conveniently without an inconvenient behavior, such as that the focus is directly adjusted or another fixed focus glasses is used when a dynamic situation or multi-focus adjustment is necessary in real time. Accordingly, the user can recognize a panorama without inconvenience attributable to a focus change even in various environments. Hereinafter, effects of the lens control device by the controller 140 are described.

In an embodiment, the lens control device may generate a focus adjustment model that handles newly changing preference and a change in the eyesight of a user through consistent model updates. This is performed through re-training by the controller 140. When an object detected by the AI model and object detected by the eye tracker are not identical with each other or an error that falls outside a predetermined distance threshold value is accumulated by a specific reference point or more, the re-training is performed. Upon re-training, a system that performs the re-training by using only small data compared to the existing training, that enables a model to adjust a balance between plasticities that are changed due to the existing stability and training, and that may handle even a changing environment is constructed. For example, when negative feedback occurring due to a change in personal preference attributable to a change of the time and trend or due to a decrease of the eyesight of a user attributable to presbyopia is input, a model minimizes inconvenience attributable to the change through re-training based on a new environment.

In an embodiment, the lens control device constructs rich data including various people's intent through the eye tracker on which complex sensors, such as an IMU and an infrared sensor, are mounted, and performs training based on the rich data. Furthermore, the eye tracker provides a function for precisely adjusting the focus of the variable-focus lens by grafting a model that is trained based on a result of the determination of the AI model onto a distance. Furthermore, the eye tracker recalculates the focus rapidly by synchronizing the distance sensor with an object that is detected as top priority. Accordingly, it is possible to automatically adjust the focus correctly and rapidly in a situation in which the focus is changed in real time.

In other words, the controller 140 determines which object needs to be focused based on information transmitted by the gaze determination unit 120. To this end, the controller 140 first determines whether information on an object determined to be a top-priority object and an object within a correct answer ROI of the eye tracker are identical with each other. When the result value of the focus determination unit is correctly identical with the tracking value of the eye tracker, the controller 140 transmits a focus that is newly calculated by measuring a distance up to a corresponding object to the lens as a control signal.

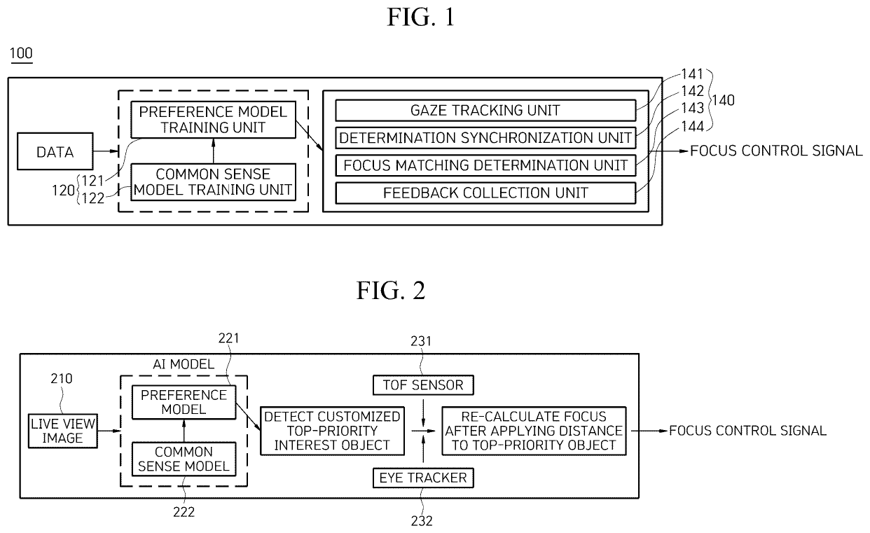

FIG. 2 is a diagram for describing a lens control process according to various embodiments.

Referring to FIG. 2, the lens control process according to an embodiment is as follows. When a live view image 210 is input to the focus-variable lens, a video image experiences an AI process within a smart lens, in particular, a processing process of the preference model during the AI process. A result value derived by the gaze tracking unit experiences a process of generating a focus control signal through the controller. In other words, the process includes the live view image 210, that is, an input, determination logic of the gaze matching determination unit, alignment between the determination logic and several sensors, and the generation of a focus control signal.

An information input process is as follows. When the live view image 210 is input to the focus-variable lens, video image information is transmitted to the lens control device.

The transmitted information is processed by a common sense model 222 trained by the training unit of the common sense model 222 within the gaze determination unit 120. The processed information is processed by the preference model 221 that is trained by the training unit of the preference model 221. Specifically, the preference model 221 generates personalized top-priority interest object detection information.

The controller 140 generates a focus control signal based on the personalized top-priority interest object detection information. Specifically, the controller calculates a focus again after applying a distance to a top-priority object through the personalized top-priority interest object detection information and alignment between the determination logic and several sensors. Thereafter, the controller generates a focus control signal suitable for the results of the calculation of the focus. The several sensors may include the eye tracker 232 and the ToF sensor 231.

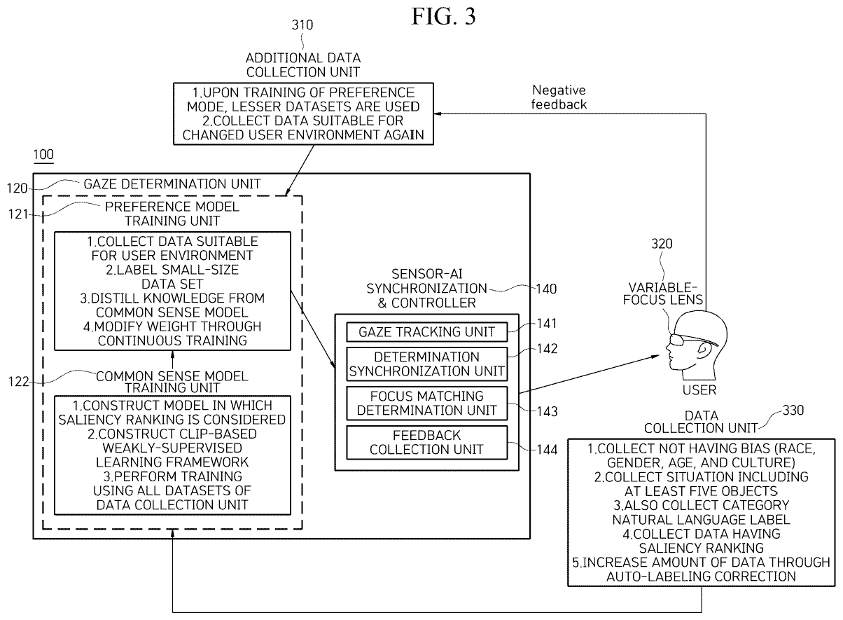

FIG. 3 is a diagram for describing a smart variable-focus lens 320 according to various embodiments.

Referring to FIG. 3, the smart variable-focus lens 320 according to an embodiment includes a data collection unit 330, an additional data collection unit 310, the lens control device 100, and a variable-focus lens 320.

The data collection unit 330 may collect basic data for training a model and collect an unbiased dataset for assigning common sense to the AI model. In order to construct the unbiased dataset, the AI model functions as a device that excludes the bias of a person who produces the unbiased dataset as much as possible by considering deviations, such as a race, gender, a culture, and an age. The dataset is input to the gaze determination unit 120 for training the model. Hereinafter, a detailed method of generating the dataset is described.

It is important for the data collection unit 330 to exclude a data labeler's bias as much as possible and to secure rich data in order to train the common sense model that will become a reference point for a primary determination and for the common sense model to function. The data collection unit 330 collects data in five steps.

The first step is to collect unbiased data. It is necessary to collect data in various environments in order to remove a bias because an object that is importantly viewed may be different depending on living local culture. Specifically, in order to collect unbiased data, test subjects are uniformly collected so that a bias does not occur in a race, gender, an age, and culture. Data may be collected in various environments in addition to the existing famous datasets (e.g., MS-COCO and ImageNet) environments based on the test subjects.

The second step is to collect a situation including at least five objects because ranking may be determined in 1,000,000 copies or more and multiple objects at a level similar to MS-COCO depending on conditions for a dataset. Gaze fixation duration of a subject is checked by using an eye tracking camera. Labeling that extracts importance based on the gaze fixation duration is performed.

The third step is to collect data having a multi-modality characteristic similar to common sense by also collecting a natural language label including ranking information and category information along with labeling.

The fourth step is a step of constructing a dataset including information on an image, a natural language tag (ranking and a category), a saliency ranking label, and a salient object boundary label by generating a label that assigns saliency ranking.

An object of the fifth step is to collect a dataset through a task for explosively breeding the size of the dataset. Specifically, the fifth step includes three steps. Auto-labeling is performed on a new dataset that has not been labeled by using a model that is trained by data collected up to the fourth step. A new dataset (up to 5 million copies) is generated through the modification of a mask and a natural language prompt by a labeler. Accordingly, the model is re-trained (Manual). A model that is newly modified by richer data has better performance. Auto-labeling is performed on new data by the model. In this case, a labeler performs a manual role of filling only a missed part. The size (up to 10 million copies) of a dataset is bred. Such a process may be performed semi-automatically.

The data collection unit 330 may secure about 1 billion copies of images and labels by performing auto-labeling. This process may be automatically performed. Finally generated data will be collected 1) without a bias and 2) richly to the extent that a human's common sense can be incorporated into the data. Accordingly, a trained model may have general performance in various situations. A model that is trained by using a dataset has elaborate performance.

The additional data collection unit 310 performs re-training based on feedback received from a user. Specifically, when negative feedback is received from a user and feedback attributable to synchronization and a feedback signal through a change in user preference are received from the controller 140, the additional data collection unit 310 changes the weight of the existing model through small-size additional-data collection. When additional data are collected, the additional data collection unit 310 performs training by using lesser datasets than those collected by the preference model training unit, and collects 20 to 30 copies of new data in a changed environment (e.g., a newly changed environment of an environment around a company or a home) of a user. The collected data are input to the preference model training unit again. The additional data collection unit 310 performs weight modification based on the user preference by performing training again. The user can easily perform focus adjustment through newly modified focus-variable glasses even in a changing eyesight and preference. A model that is newly trained by the re-training of the additional data collection unit 310 may incorporate the user preference newly again. As the re-training process is consistently repeated, the AI model is grown suitably for the user. The user can also continuously perform current real-time adjustment and improve an error which may occur in the future.

Specifically, the additional data collection unit 310 may provide a function for consistently updating and improving a focus prediction model in accordance with a change of a long-term eyesight according to a change in user preference or an age increase or diseases. A user can maintain consistently convenient visual experiences. For example, when a user suffers from presbyopia or cataract, the present disclosure improves a model by detecting presbyopia or cataract in real time and consistently accumulating learning data suitable for a corresponding situation. Accordingly, the user can be automatically provided with an optimal focus without the need to replace a lens although the eyesight of the user is changed.

In other words, when the results of the eye tracker and an AI result value are not consistently identical with each other or there is negative feedback through a change of user preference and an eyesight change, the additional data collection unit 310 performs re-training on a current re-training model based on additional data.

The variable-focus lens 320 is a lens that is used in glasses, and is a lens the focus of which may be changed based on a signal. In an embodiment, the variable-focus lens may be a lens to which a lens-in-foil technology has been applied. Specifically, a lens may be formed within and mounted on a thin and flexible foil, and the focus of the lens may be aligned by adjusting the foil. However, the variable-focus lens 320 is not limited to the technology, and may be a lens to which other technologies which may be adopted by those skilled in the art have been applied.

The lens control device 100 may be the lens control device described with reference to FIG. 1, and is described in brief. The lens control device 100 according to an embodiment includes the gaze determination unit 120 and the controller 140. Specifically, the gaze determination unit 120 includes the preference model training unit 121 and the common sense model training unit 122. The controller 140 includes the gaze tracking unit 141, the determination synchronization unit 142, the focus matching determination unit 143, and the feedback collection unit 144. Detailed contents of such components have been described with reference to FIG. 1. However, the present disclosure is not limited thereto, and various lens control devices which may be adopted by those skilled in the art may be used.

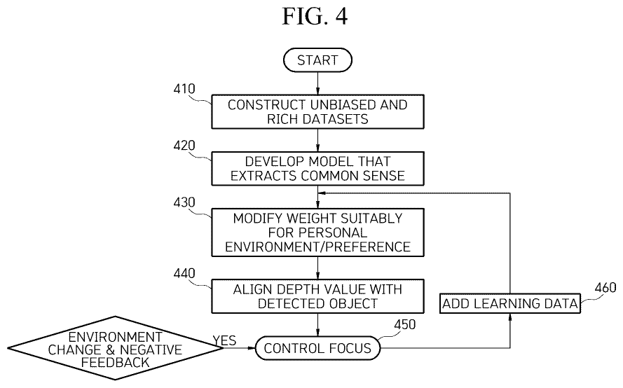

FIG. 4 is a control flowchart through the lens control device according to various embodiments.

Referring to FIG. 4, the control flowchart through the lens control device according to an embodiment includes a dataset construction step 410, a model development step 420, a weight modification step 430 based on a personal environment, a depth value alignment step 440 for a detected object, a focus control step 450, and a learning data addition step 460 based on feedback for an environment change.

In the dataset construction step 410, unbiased and rich datasets are constructed. The dataset construction step 410 is the same as the aforementioned data collection step of the data collection unit in the smart variable-focus lens. In other words, the data collection unit collects data in five steps.

The first step is to collect unbiased data. It is necessary to collect data in various environments in order to remove a bias because an object that is importantly viewed may be different depending on living local culture. Specifically, in order to collect unbiased data, test subjects are uniformly collected so that a bias does not occur in a race, gender, an age, and culture. Data may be collected in various environments in addition to the existing famous datasets (e.g., MS-COCO and ImageNet) environments based on the test subjects.

The second step is to collect a situation including at least five objects because ranking may be determined in 1,000,000 copies or more and multiple objects at a level similar to MS-COCO depending on conditions for a dataset. Gaze fixation duration of a subject is checked by using an eye tracking camera. Labeling that extracts importance based on the gaze fixation duration is performed.

The third step is to collect data having a multi-modality characteristic similar to common sense by also collecting a natural language label including ranking information and category information along with labeling.

The fourth step is a step of constructing a dataset including information on an image, a natural language tag (ranking and a category), a saliency ranking label, and a salient object boundary label by generating a label that assigns saliency ranking.

An object of the fifth step is to collect a dataset through a task for explosively breeding the size of the dataset. Specifically, the fifth step includes three steps. Auto-labeling is performed on a new dataset that has not been labeled by using a model that is trained by data collected up to the fourth step. A new dataset (up to 5 million copies) is generated through the modification of a mask and a natural language prompt by a labeler. Accordingly, the model is re-trained (Manual). A model that is newly modified by richer data has better performance. Auto-labeling is performed on new data by the model. In this case, a labeler performs a manual role of filling only a missed part. The size (up to 10 million copies) of a dataset is bred. Such a process may be performed semi-automatically.

The data collection unit 330 may secure about 1 billion copies of images and labels by performing auto-labeling. This process may be automatically performed. Finally generated data will be collected 1) without a bias and 2) richly to the extent that a human's common sense can be incorporated into the data. Accordingly, a trained model may have general performance in various situations. A model that is trained by using a dataset has elaborate performance.

In the model development step 420, a model that extracts common sense is developed. The model development step is the same as the aforementioned common sense model training process of the common sense model training unit. In other words, the common sense model training unit may include a model that constructs saliency ranking. Specifically, the common sense model training unit may include a model that outputs an output value (e.g., segment logit) as an output, like a salient object detection model that contains the order of importance in an environment including five or more multiple objects when receiving information on a surrounding environment in the form of a live view through a camera. Hereinafter, a detailed method of generating a common sense model is described. In order to generate a model close to a model for a human's common sense, data and a model need to have multi-modality. The common sense model needs to be a model capable of inferring a relation between data. Common performance needs to be produced from several situations through a rich dataset into which preference of various labelers has been incorporated without a bias. Data that are received by the common sense model also includes a natural language tag label including ranking information and category information, in addition to an image, a salient label, and a ranking label. Accordingly, the common sense model may be trained by inputting both a natural language and image information thereto. To this end, the encoder of the common sense model may include an image encoder and a text encoder, and receives each image and natural language tag as an input. The latent of the encoder, which is compressed by the text encoder, is input to a transition encoder for a combination with image latent. The output of the transition encoder and the latent of the image encoder are combined through a cross-attention process, and a model decoder outputs a final salient object logit, thereby training the common sense model. As in a data proliferation process to be described hereafter, the improvement training of the model may also be performed along with the proliferation of data, including a method of training the model through the existing dataset and performing auto-labeling again as an improved model after the auto-labeling is performed. Accordingly, the model can be trained while watching a rich dataset. Detailed training of the model is described below. A model close to a model for common sense may be generated by training the model through a detection label necessary for the detection of a salient object and also training the model through a natural language label including ranking information and category information like a category label. The model through such training can provide a primary criterion in lens control. The model may be trained by using all of collected data.

In the weight modification step 430, a weight is modified based on a personal environment or preference. The weight modification step is the same as the aforementioned preference model training process of the preference model training unit. In other words, the preference model training unit is a model training unit that provides a guideline to an object that needs to be focused by incorporating user preference as top priority above common sense. Hereinafter, a detailed method of generating a preference model is described. In order to generate the preference model, it is necessary to 1) incorporate environment information suitable for a user and 2) reset a weight based on personal preference. The user may first collect data suitable for a user environment, may collect 50 to 100 copies of data in an environment (e.g., a company, a home, or an environment for a way to and from work) in which the user stays mainly through glasses, may determine object priority for each photo in several tens of captured photos, and may perform labeling. In the case of a large-scale common sense model, it is assumed that a mask derivation and object detection ability is excellent in various situations because the large-scale common sense model has been trained based on data and transformer-based multi-modal data. In a process of re-training the preference model, output information of the common sense model may be used without performing a boundary and detection label modification task that requires a significant time. However, the user may perform a modification task that assigns priority again because priority different from common sense may be assigned to each person in a portion in which saliency ranking is determined. A photo to which several tens of annotations have been applied is input to knowledge distilled from the common sense model again. The preference model is re-trained by a new weight in a consistent training manner. Accordingly, the weight may be modified again by a model that is suitable for a personal environment and personal preference of the user. In this case, a finally trained model has the stability of a base model, and also has generality in which an inter-plasticity balance that occurs because preference is incorporated can be well adjusted. Accordingly, the finally trained model has the ability to determine a top-priority target object the focus of which is controlled rapidly and accurately. A final output signal (i.e., including priority object detection information and ranking information) derived by the gaze determination unit is transmitted to the controller 140 that performs sensor-AI synchronization. After the data collection and the training of the common sense model and the preference model is performed, the preference model is capable of real-time recognition processing. The processing of the results of the gaze determination unit is performed through the preference model. Hereinafter, effects of the lens control device by the gaze determination unit are described. When a person recognizes an environment by checking user preference, an AI model that determines an object that is most attractively viewed and takes the focus on the object may be implemented. Specifically, two reference points may be used. The first reference point is a common sense reference point. The common sense reference point may be designed by determining the place to which the gazes of most people are directed as priority when the gaze of a person is directed toward a surrounding environment. The first reference point may apply an individual variation in designing the AI model, and thus becomes a primary filter with respect to noise and an outlier which may suddenly occur. For the role of the primary filter, it is necessary to design a model that extracts importance in various environments by uniformly collecting test subjects so that a bias does not occur in gender, nationality, race, and an age and performing gaze fixation tracking. Accordingly, there is an effect in that recognition stability can be reinforced in various environments because the base model supplements a situation in which a wrong weight is learnt and thus gaze information bounces occurs although the situation occurs. If a base AI model having common sense is the first reference point that assigns the stability of selection, the second reference point is for priority object re-alignment that is suitable for individual preference and interest. When two to three candidates which may be determined to be major objects are present, the most important object is selected based on user preference from a group of the major objects along with an eye tracker. In order to select the major objects, a reference point is reset based on the user preference in various environments through the re-training of the base model, and the focus is automatically adjusted based on the reference point. Accordingly, it is possible to minimize visual fatigue and improve inconvenience of manual focus adjustment by automatically re-adjusting the focus in various situations.

In the alignment step 440, a depth value is aligned with the detected object. The alignment step is the same as the aforementioned function that is performed by the controller. In other words, the controller matches the eye tracker and the distance sensor with a top-priority object derived by the AI model. Furthermore, the controller receives a signal that detects a customized top-priority interest object through the AI model. Thereafter, the controller transmits a control signal to the focus-variable lens through the gaze tracking unit, the determination synchronization unit, the focus matching determination unit, and the feedback collection unit.

The gaze tracking unit is based on gaze information received from the eye tracker. Before an interest object is detected by the AI model, the eye tracker of variable focus glasses plays a role of tracking the gaze fixing point of a user, consistently monitoring the accuracy of an object detection algorithm, supplementing a determination of the AI model, and generating a feedback signal for additional training. Accordingly, there is an effect in that a user can consistently make an accurate focus change.

The determination synchronization unit identifies whether a top-priority object detected by the AI model and a top-priority object of a gaze detected by the eye tracker are identical with each other, and synchronizes the top-priority objects. To this end, the determination synchronization unit sets a region of interest (ROI) around gaze fixing points (pixels) that are tracked by the eye tracker as an area (in an embodiment, 50 pixels) of surrounding specific pixels, which has a circle form.

The focus matching determination unit determines an object by using an algorithm which may be constructed based on pseudo code illustrated in the FIG. 1. Hereinafter, the contents of the pseudo code are described in detail.

The focus matching determination unit determines how much the tracking data of the eye tracker and an AI determination value are matched by comparing the tracking data and the AI determination value. Specifically, the focus matching determination unit determines how much an AI determination value is identical with the gaze tracking result value of the eye tracker by using a point at which the eye tracker currently tracks the gaze of a user as a reference point and placing a preset specific region (e.g., 50 pixels) around the reference point as a threshold reference value. When the AI determination value is included in the result value ROI of the eye tracker as a result of the determination of the focus matching determination unit, the focus matching determination unit finds the most important object as the AI determination value and aligns an eye tracker fixation point and the AI determination value. Thereafter, the focus matching determination unit may calculate the middle point of the most important object and calculate a distance value by placing a TOF sensor at the middle point. In contrast, when the result value ROI of the eye tracker and the AI determination value are not identical with each other, the focus matching determination unit checks a case in which the result value ROI and the AI determination value are not identical with each other based on a flag variable, derives a top-priority object by using the AI determination value as top priority, and aligns the depth sensor with the AI determination value. When the flag variable falls outside a specific value, the focus matching determination unit determines a change of user preference or determines whether to re-train a determination model by determining that the determination model is not correct. The focus matching determination unit may determine both sensor alignment and the re-training through such a process. The determination synchronization unit synchronizes the gaze point of the eye tracker and the AI determination object. Furthermore, the determination synchronization unit generates a final control signal for the lens by measuring a distance up to a final middle point of the top-priority object. As a result, the lens control device transmits a control signal generated by the controller to the focus-variable lens. The focus-variable lens is automatically adjusted by the control signal. Accordingly, an object that is gazed by a user can be accurately identified based on user interest, and the focus of the user can be automatically changed by measuring a distance up to the object in real time. Accordingly, there is an effect in that a constant view can be provided conveniently without an inconvenient behavior, such as that the focus is directly adjusted or another fixed focus glasses is used when a dynamic situation or multi-focus adjustment is necessary in real time. Accordingly, the user can recognize a panorama without inconvenience attributable to a focus change even in various environments.

The learning data addition step 460 is the same as the aforementioned additional data collection step of the additional data collection unit in the smart variable-focus lens. In other words, the additional data collection unit performs re-training based on feedback received from a user. Specifically, when negative feedback is received from a user and feedback attributable to synchronization and a feedback signal through a change in user preference are received from the controller, the additional data collection unit changes the weight of the existing model through small-size additional-data collection. When additional data are collected, the additional data collection unit performs training by using lesser datasets than those collected by the preference model training unit, and collects 20 to 30 copies of new data in a changed environment (e.g., a newly changed environment of an environment around a company or a home) of a user. The collected data are input to the preference model training unit again. The additional data collection unit performs weight modification based on the user preference by performing training again. The user can easily perform focus adjustment through newly modified focus-variable glasses even in a changing eyesight and preference. A model that is newly trained by the re-training of the additional data collection unit may incorporate the user preference newly again. As the re-training process is consistently repeated, the AI model is grown suitably for the user. The user can also continuously perform current real-time adjustment and improve an error which may occur in the future. Specifically, the additional data collection unit may provide a function for consistently updating and improving a focus prediction model in accordance with a change of a long-term eyesight according to a change in user preference or an age increase or diseases. A user can maintain consistently convenient visual experiences. For example, when a user suffers from presbyopia or cataract, the present disclosure improves a model by detecting presbyopia or cataract in real time and consistently accumulating learning data suitable for a corresponding situation. Accordingly, the user can be automatically provided with an optimal focus without the need to replacing a lens although the eyesight of the user is changed. In other words, when the results of the eye tracker and an AI result value are not consistently identical with each other or there is negative feedback through a change of user preference and an eyesight change, the additional data collection unit performs re-training on a current re-training model based on additional data.

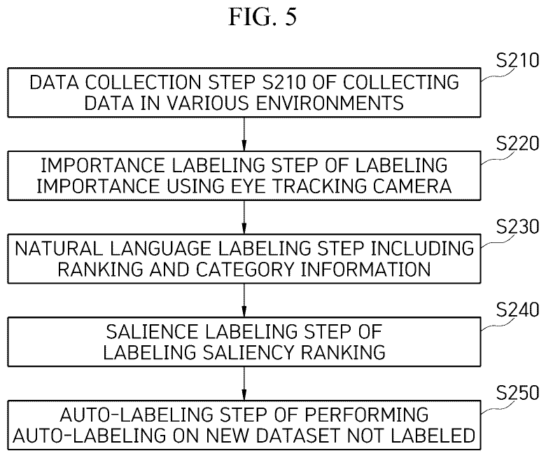

FIG. 5 is a diagram for describing the data collection step S210 in the data collection unit according to various embodiments.

Referring to FIG. 5, the data collection step of the data collection unit of the smart variable-focus lens according to an embodiment includes a data collection step S210, an importance labeling step S220, a natural language labeling step S230, a saliency labeling step S240, and an auto-labeling step S250.

An object of the data collection step S210 is to collect unbiased data. It is necessary to collect data in various environments in order to remove a bias because an object that is importantly viewed may be different depending on living local culture. Specifically, in order to collect unbiased data, test subjects are uniformly collected so that a bias does not occur in a race, gender, an age, and culture. Data may be collected in various environments in addition to the existing famous datasets (e.g., MS-COCO and ImageNet) environments based on the test subjects.

In the importance labeling step S220, importance is extracted, and labeling is performed on the importance. Specifically, a situation including at least five objects because ranking may be determined in 1,000,000 copies or more and multiple objects at a level similar to MS-COCO is collected depending on conditions for a dataset. Gaze fixation duration of a subject is checked by using an eye tracking camera. Labeling that extracts importance based on the gaze fixation duration is performed.

The natural language labeling step S230 is a step of collecting a natural language label. Specifically, data having a multi-modality characteristic similar to common sense are collected by also collecting a natural language label including ranking information and category information along with labeling.

The saliency labeling step S230 is a step of constructing a dataset including information on an image, a natural language tag (ranking and a category), a saliency ranking label, and a salient object boundary label by generating a label that assigns saliency ranking.

The auto-labeling step S250 is a step of collecting the dataset. Specifically, the auto-labeling step S250 includes three steps. Auto-labeling is performed on a new dataset that has not been labeled by using a model that is trained by data collected up to the saliency step. A new dataset (up to 5 million copies) is generated through the modification of a mask and a natural language prompt by a labeler. Accordingly, the model is re-trained (Manual). A model that is newly modified by richer data has better performance. Auto-labeling is performed on new data by the model. In this case, a labeler performs a manual role of filling only a missed part.

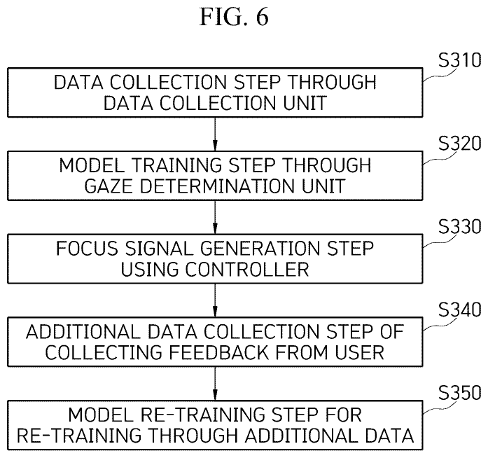

FIG. 6 is a flowchart for describing a method of controlling a variable-focus lens according to various embodiments.

Referring to FIG. 6, the variable-focus lens control method according to an embodiment includes a data collection step S310, a model training step S320, a focus signal generation step S330, an additional data collection step S340, and a model re-training step S350.

In the data collection step S310, data are collected by using the data collection unit of a smart variable-focus lens. As described above, the data collection unit collects basic data for training a model and collects an unbiased dataset for assigning common sense to the AI model. In order to construct the unbiased dataset, the AI model functions as a device that excludes the bias of a person who produces the unbiased dataset as much as possible by considering deviations, such as a race, gender, a culture, and an age. The dataset is input to the gaze determination unit for training the model.

In the model training step S320, the AI model is trained based on the dataset by using the gaze determination unit of the lens control device. As described above, the gaze determination unit includes the common sense model training unit and the preference model training unit. The common sense model training unit may include a model that constructs saliency ranking. Specifically, the common sense model training unit may include a model that outputs an output value (e.g., segment logit) as an output, like a salient object detection model that contains the order of importance in an environment including five or more multiple objects when receiving information on a surrounding environment in the form of a live view through a camera. In addition, the preference model training unit is a model training unit that provides a guideline to an object that needs to be focused by incorporating user preference as top priority above common sense. In the model training step S320, the AI model is trained by using the common sense model training unit and the preference model training unit.

In the focus signal generation step S330, a focus signal is generated by using the controller of the lens control device. As described above, the controller matches the eye tracker and the distance sensor with a top-priority object derived from the AI model. Furthermore, the controller receives a signal that detects a customized top-priority interest object through the AI model. Thereafter, the controller transmits a control signal to a focus-variable lens through the gaze tracking unit, the determination synchronization unit, the focus matching determination unit, and the feedback collection unit.

In the additional data collection step S340, the AI model is re-trained by using the additional data collection unit of the smart variable-focus lens. As described above, when negative feedback is received from a user and feedback attributable to synchronization and a feedback signal through a change in user preference are received from the controller, the additional data collection unit changes the weight of the existing model through small-size additional-data collection. When additional data are collected, the additional data collection unit performs training by using lesser datasets than those collected by the preference model training unit, and collects 20 to 30 copies of new data in a changed environment (e.g., a newly changed environment of an environment around a company or a home) of a user.

In the model re-training step S350, the AI model is re-trained by using the new data. As described above, the newly collected data are input to the preference model training unit again. The additional data collection unit performs weight modification based on user preference by performing training again. A user can easily perform focus adjustment through newly modified focus-variable glasses even in a changing eyesight and preference. A model that is newly trained by the re-training of the additional data collection unit may incorporate the user preference newly again.

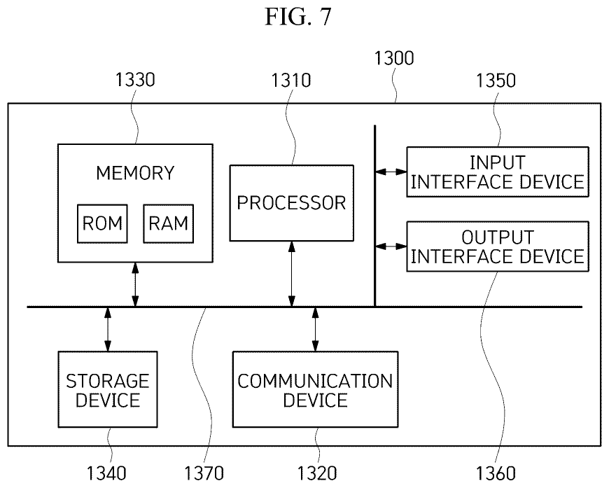

FIG. 7 is a block diagram illustrating a computer system for implementing a method according to an embodiment of the present disclosure.

Referring to FIG. 7, a computer system 1300 may include at least one of a processor 1310, memory 1330, an input interface device 1350, an output interface device 1360, and a storage device 1340, which perform communication through a bus 1270. The computer system 1300 may include a communication device 1320 that is connected to a network. The processor 1310 may be a central processing unit (CPU) or may be a semiconductor device that executes a command stored in the memory 1330 or the storage device 1340. The memory 1330 and the storage device 1340 may include various forms of volatile or nonvolatile storage media. For example, the memory may include read only memory (ROM) and random access memory (RAM). In an embodiment of this specification, the memory may be disposed inside or outside the processor. The memory may be connected to the processor through various already-known means. The memory may be various forms of volatile or nonvolatile storage media. For example, the memory may include read-only memory (ROM) or random access memory (RAM).

Accordingly, an embodiment of the present disclosure may be implemented as a method implemented in a computer or may be implemented as a non-transitory computer-readable medium in which a computer-executable instruction has been stored. In an embodiment, when being executed by a processor, a computer-readable instruction may perform a method according to at least one aspect of this writing.

The communication device 1320 may transmit or receive a wired signal or a wireless signal.

Furthermore, the method according to an embodiment of the present disclosure may be implemented in the form of a program instruction which may be executed through various computer means, and may be recorded on a computer-readable medium.

The computer-readable medium may include a program instruction, a data file, and a data structure alone or in combination. A program instruction recorded on the computer-readable medium may be specially designed and constructed for an embodiment of the present disclosure or may be known and available to those skilled in the computer software field. The computer-readable medium may include a hardware device configured to store and execute the program instruction. For example, the computer-readable medium may include magnetic media such as a hard disk, a floppy disk, and a magnetic tape, optical media such as CD-ROM and a DVD, magneto-optical media such as a floptical disk, ROM, RAM, and flash memory. The program instruction may include not only a machine code produced by a compiler, but a high-level language code capable of being executed by a computer through an interpreter.

The embodiments of the present disclosure have been described in detail, but the scope of rights of the present disclosure is not limited thereto. A variety of modifications and changes made by those skilled in the art using the basic concept of the present disclosure defined in the appended claims are also included in the scope of rights of the present disclosure.

1. A lens control device, comprising:
a gaze determination processor configured to train a common sense model based on a common sense dataset and train a preference model device based on user preference data; and
a controller configured to control a focus of a lens based on a result value derived by the preference model,
wherein the preference model is a device that is trained using datasets collected from a user environment and having a size that is smaller than a dataset used for training the common sense model.

2. The lens control device of claim 1, wherein the gaze determination processor comprises:
a common sense model training unit configured to train the common sense model which determines a priority of a gaze based on common sense; and
a preference model training unit configured to train the preference model that aligns results determined by the common sense model by incorporating user preference.

3. The lens control device of claim 1, wherein the controller comprises:
a gaze tracking unit configured to track a gaze fixing point of a user;
a determination synchronization unit configured to identify and synchronize whether the gaze fixing point of the user and a gaze determined by the preference model are identical with each other;
a focus matching determination unit configured to determine an object by using an algorithm; and
a feedback collection unit configured to collect feedback of a user with respect to whether focuses determined by the algorithm are identical with each other.

4. The lens control device of claim 2, wherein the common sense model training unit comprises:
an image encoder configured to encode an image; and
a text encoder configured to encode text.

5. The lens control device of claim 1, wherein the controller comprises a focus matching determination unit having an algorithm that determines whether a result value, which is determined by using a point at which an eye tracker tracks a gaze as a reference point and setting 50 pixels around the reference point as a threshold, is identical with a gaze tracking result value of the eye tracker.

6. A smart variable-focus lens, comprising:
a data collection unit configured to collect data to train the common sense model;
an additional data collection unit configured to collect small-scale data based on a feedback signal;
the lens control device of claim 1; and
a variable-focus lens having a changeable focus.

7. The smart variable-focus lens of claim 6, wherein the data collection unit is configured to:
collect data in various environments,
label importance by using an eye tracking camera,
label a natural language comprising ranking information and category information,
label saliency ranking, and
auto-label new dataset that is not labeled.

8. The smart variable-focus lens of claim 6, wherein the data collection unit is further configured to collect the data so that a bias does not occur by differentiating one or more of a race, gender, an age, and culture of a test subject.

9. The smart variable-focus lens of claim 6, wherein the data collection unit is further configured to generate a dataset by collecting data comprising one or more of pieces of information on an image, a natural language tag, a saliency ranking label, and a salient object boundary label.

10. The smart variable-focus lens of claim 6, wherein the data collection unit is further configured to generate a dataset by collecting data a size of which is increased, by repeating a process of auto-labeling a new dataset that is not labeled, re-training a model a dataset generated through auto-labeling, and auto-labeling new data by using the re-trained model.

11. (canceled)

12. A lens control method, comprising:
a model training step of training, by a gaze determination processor, a common sense model based on a common sense dataset and train a preference model device based on user preference data; and
a focus signal generation step of controlling, by a controller, a focus of a lens based on a result value derived by the preference model,
wherein the preference model a device that is trained using datasets collected from a user environment and having a size that is smaller than a dataset used for training the common sense model.

13. The lens control method of claim 12, further comprising:
a data collection step of using a data collection unit prior to the model training step;
an additional data collection step of collecting feedback of a user with respect to whether the focus of the lens matches the user's focus are identical with each other; and
a model re-training step of re-training a model based on the feedback of the user.

14. The lens control method of claim 12, further comprising:
an importance labeling step of labeling importance by using an eye tracking camera;
a natural language labeling step of labeling a natural language comprising one or more of ranking information and category information;
a saliency labeling step of labeling saliency ranking; and
an auto-labeling step of auto-labeling a new dataset that is not labeled.

15. The lens control method of claim 12, further comprising a data collection step of collecting the collected data so that a bias does not occur by making different one or more of a race, gender, an age, and culture of a test subject.

16. The lens control method of claim 12, further comprising a data collection step of generating a dataset comprising pieces of information on an image, a natural language tag, a saliency ranking label, and a salient object boundary label.

17. The lens control method of claim 12, further comprising a data collection step of generating a dataset a size of which is increased, by repeating a process of auto-labeling a new dataset that is not labeled, re-training a model a dataset generated through auto-labeling, and auto-labeling new data by using the re-trained model.

18. The lens control method of claim 12, wherein the model training step comprises:
a common sense model training step of training a common sense model based on a common sense dataset that is previously collected; and
a preference model training step of training a preference model based on a dataset comprising user preference.

19. The lens control method of claim 12, wherein the focus signal generation step comprises:
a gaze tracking step of tracking a gaze fixing point of a user;
a synchronization step of identifying and synchronizing whether the gaze fixing point of the user and a gaze determined by the preference model are identical with each other;
a focus matching determination step of determining an object by using an algorithm; and
a feedback collection step of collecting feedback of a user with respect to whether focuses determined by the algorithm are identical with each other.

20. (canceled)
